(19) United States
(12) Patent Application Publication
(10) Pub. No.: US 2014/0125159 A1
(43) Pub. Date: May 8, 2014

(54) POWER TOOL

(71) Applicants: Yutaka Ito, Hitachinaka (JP); Tomomasa Nishikawa, Hitachinaka (JP); Tetsuhiro Harada, Hitachinaka (JP); Yoshihiro Nakano, Hitachinaka (JP); Hiroki Uchida, Hitachinaka (JP); Tomoyuki Hoshi, Hitachinaka (JP)

(72) Inventors: Yutaka Ito, Hitachinaka (JP); Tomomasa Nishikawa, Hitachinaka (JP); Tetsuhiro Harada, Hitachinaka (JP); Yoshihiro Nakano, Hitachinaka (JP); Hiroki Uchida, Hitachinaka (JP); Tomoyuki Hoshi, Hitachinaka (JP)

(73) Assignee: HITACHI KOKI CO., LTD., Tokyo (JP)

(21) Appl. No.: 14/129,912

(22) PCT Filed: Aug. 15, 2012
(86) PCT No.: PCT/JP2012/005165

§ 371 Date: Dec. 27, 2013

(30) Foreign Application Priority Data
Sep. 30, 2011 (JP) 2011-217644

(51) Int. Cl. B25F 5/00; H02K 5/10

(52) U.S. Cl. CPC B25F 5/008; H02K 5/10
USPC 310/50

(57) ABSTRACT

A power tool capable of preventing entrance of foreign matter or water etc. through the air hole as much as possible is provided. To prevent foreign matter from entering a housing 2 through a outlet 22, a first through hole 70b penetrating a main wall 71 is formed on a part of the main wall 71 of a cover 70 covering the outlet 22, second through holes 70c are formed on: a part closest to a front end portion of the cover 70; an end portion in the extending direction of the handle of the cover 70; and an end portion in the opposite direction to the extending direction of the handle of the cover 70.

### TECHNICAL FIELD

The present invention relates to a power tool, and especially relates to a power tool in which a motor is used as a source of power.

### BACKGROUND ART

Traditionally, a power tool, in which a motor is used as a source of power, is provided with a fan for cooling the motor etc. A housing to accommodate this motor and the fan is provided with an air hole forming an inlet for taking in the outside air into the housing or an outlet for discharging the air in the housing to the outside (Refer to Patent Literature 1).

### CITATION LIST

### Patent Literature

PTL 1: Japanese Patent Application Laid-Open Publication No. 07-266260

### SUMMARY OF INVENTION

### Technical Problem

Taking into consideration the efficiency of air intake and exhaust, an air hole forming either an outlet or an inlet may be formed near the fan. However, there has been a risk that a foreign matter entered through the air hole formed near the fan causes lock and damage of the fan, a short circuit of the motor. Moreover, rain etc. flew into the housing through the air hole may cause damage to the motor etc.

It is an object of the present invention to provide a power tool which can prevent entrance of foreign matters or water through the air hole as much as possible.

### Solution to Problem

The present invention provides a power tool including a motor for driving the tip tool; a housing accommodating the motor; an air hole formed in the housing and connecting the outside and the inside of the housing, in which a cover for covering the air hole is provided to the outside of the housing; a first through hole is formed on a part off from a part of the cover facing the air hole in the direction connecting the outside and the inside of the housing, penetrating the cover in a direction connecting the outside and the inside of the housing; a second through hole is formed on another part of the cover, penetrating the cover in a direction along an exterior surface of the housing.

The first through hole is formed on the part off from the part of the cover facing the air hole in the direction connecting the outside and the inside of the housing, penetrating the cover in a direction connecting the outside and the inside of the housing.

The second through hole is formed on another part of the cover, penetrating the cover in a direction along an exterior surface of the housing.

Therefore, water and foreign matter which entered from the outside of the cover through the first through hole collides with the housing and do not enter into the housing through the air hole of the housing. Then, the water and foreign matter fall with the gravity along the external surface of the housing and are discharged through the second through hole to the outside of the cover. Moreover, the first through hole and the second through hole ensure sufficient flow passage area for air flow and prevent the flow of the air from being blocked.

In an embodiment of the present invention, the cover has a housing-facing surface which faces the housing. Moreover, a projection projecting toward the air hole is provided on a part of the housing-facing surface and which faces the air hole, and the external surface of the projection includes a curved surface smoothly connecting a projecting end of the projection and the housing-facing surface. In this embodiment, an external surface of the projection can guide the air flowing into the air hole when the air hole is the inlet port of the air into the housing. Moreover, the external surface of the projection can guide the air flowing out of the air hole when the air hole is the outlet port of the air to the outside of the housing. For this reason, the air can be smoothly passed between the cover and the housing, and stagnation of the air between the cover and the housing can be prevented.

In another embodiment of the present invention, a protective barrier arranged to project from the exterior surface of the housing and to surround the air hole is provided on a part which is a part of the exterior surface of the housing and which surrounds the air hole. In this embodiment, water and foreign matter moving along the external surface of the housing can be prevented from entering the air hole with the protective barrier.

In another embodiment of the present invention, the protective barrier and the cover are formed in one piece. In this embodiment, the increase in the parts count concerning the protective barrier can be prevented.

In still another embodiment of the present invention, the protective barrier and the housing are formed in one piece. In this embodiment, the strength of the protective barrier can be increased. Moreover, the protective barrier can be easily formed compared with a configuration in which the cover and the protective barrier are formed in one piece.

In still another embodiment of the present invention, a fan driven by the motor is provided and the air hole formed on a part of the housing facing the fan's periphery. In this embodiment, foreign matter which disturbs the fan's rotation can be prevented from entering through the air hole. Therefore, a power tool which satisfies the IP standard defined in JIS C 0920 can be achieved.

In another embodiment of the present invention, the housing includes: a tip portion for supporting the tip tool; a rear end portion on the opposite end of the tip portion; and a handle extending in a direction intersecting the direction connecting the tip portion and the rear end portion. The second through hole is formed on: a part closest to a front end portion of the cover; an end portion in an extending direction of the handle of the cover; and an end portion in a direction opposite to the extending direction of the handle of the cover. In this embodiment, when working on fastening of threads etc. with the tip tool, the direction from the first through hole to the second through hole nearly coincides with the gravity direction. Therefore, the rain and foreign matter flowed in between the cover and the housing through the first through hole can be easily discharged from the second through hole.

In another embodiment of the present invention, the cover can be removed from the housing. In this embodiment, even when foreign matter remains between the housing and the cover, the foreign matter can be easily removed by removing the cover from the housing.

### Advantageous Effects of Invention

According to the present invention, a power tool which can prevent entrance of foreign matter, water, and etc. through the air hole as much as possible is achieved.

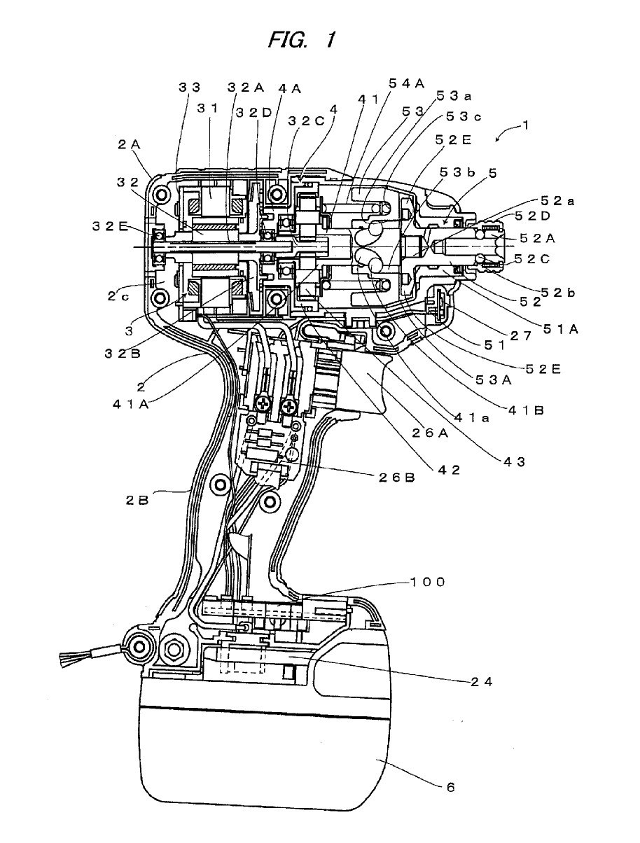

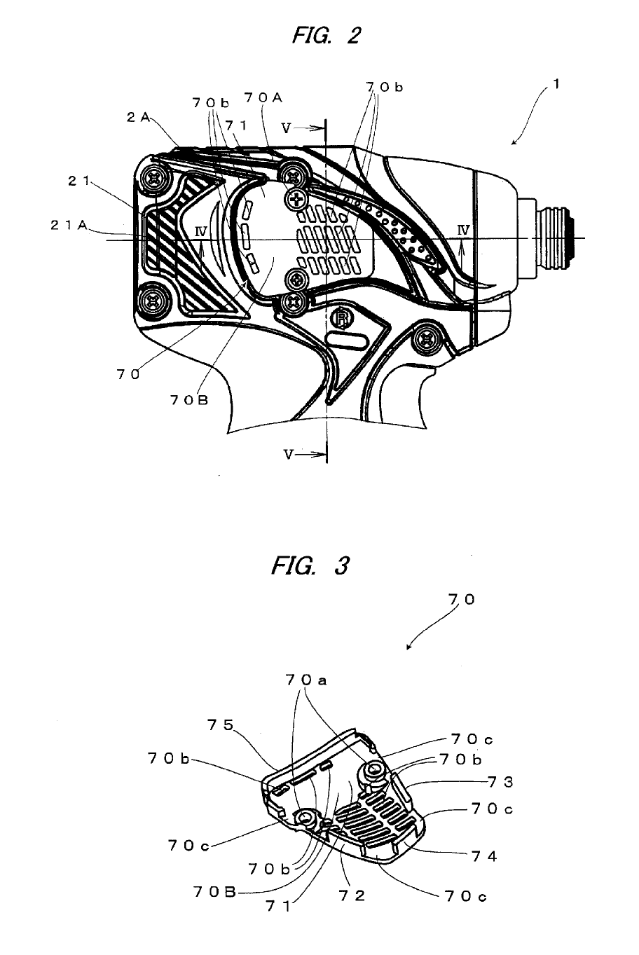

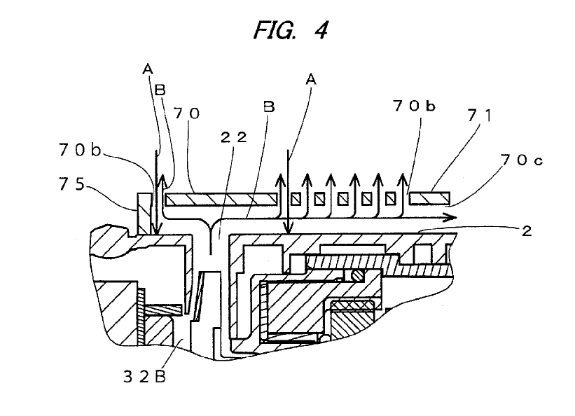

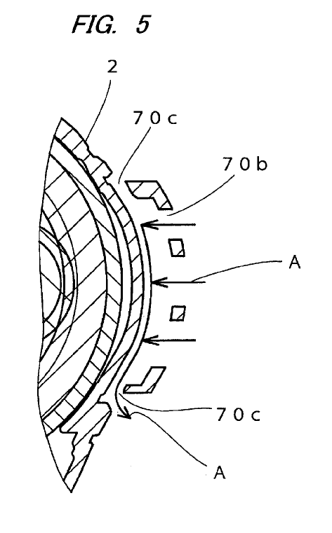

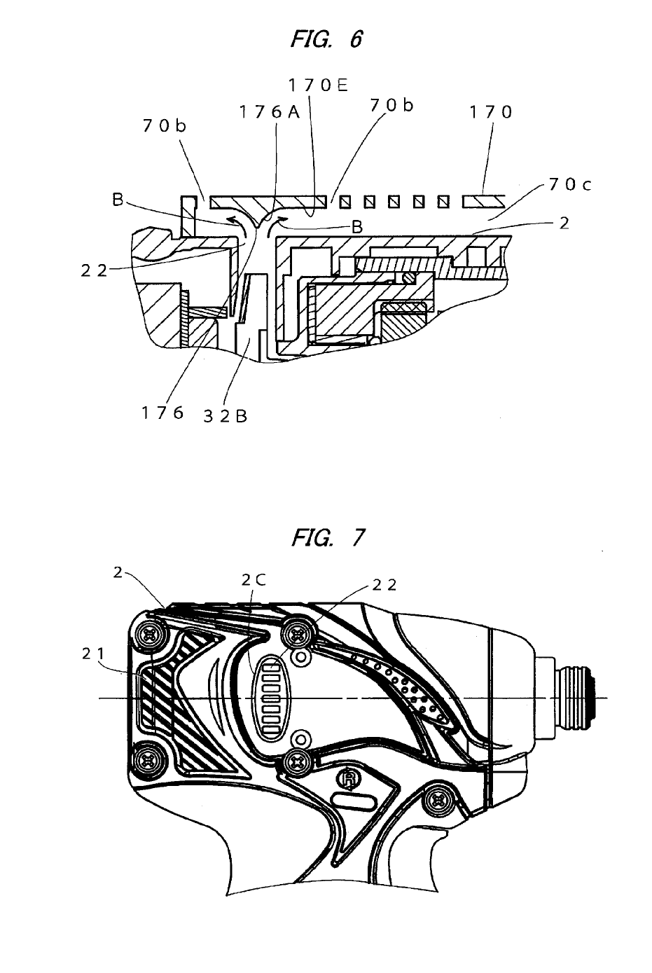

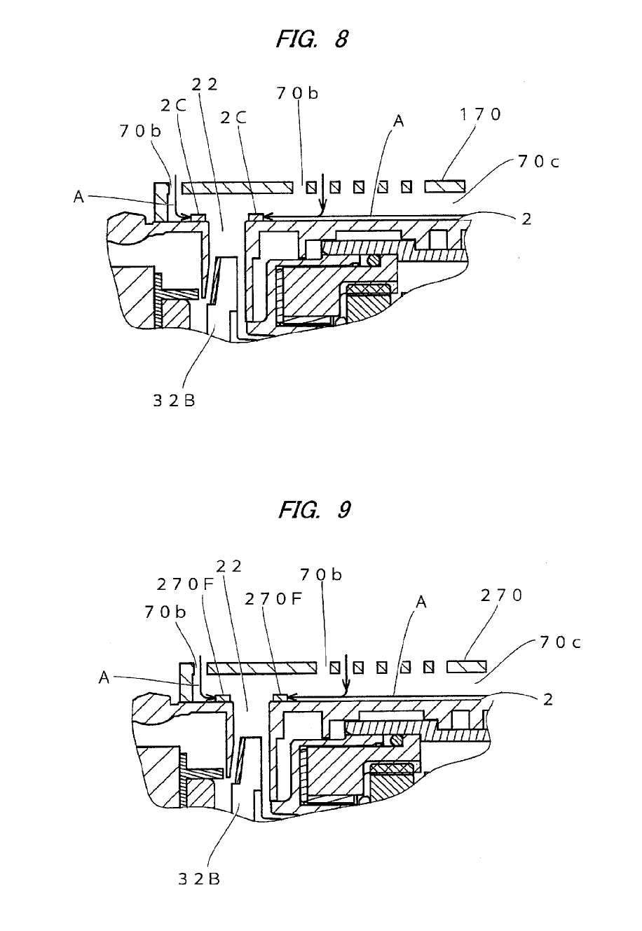

### BRIEF DESCRIPTION OF DRAWINGS

[FIG. 1] FIG. 1 is a cross-sectional view illustrating a power tool according to an embodiment of the present invention.

[FIG. 2] FIG. 2 is a side view illustrating the main section of the power tool in accordance with the embodiment of the present invention.

[FIG. 3] FIG. 3 is a perspective view illustrating a cover of the power tool according to the embodiment of the present invention.

[FIG. 4] FIG. 4 is a cross-sectional view taken along the line IV-IV of FIG. 2.

[FIG. 5] FIG. 5 is a cross-sectional view taken along the line V-V of FIG. 2.

[FIG. 6] FIG. 6 is a cross-sectional view illustrating a first modification example of the main section of the power tool according to the embodiment of the present invention.

[FIG. 7] FIG. 7 is a side view illustrating a third modification example of the main section of the power tool according to the embodiment of the present invention.

[FIG. 8] FIG. 8 is a cross-sectional view illustrating the third modification example of the main section of the power tool according to the embodiment of the present invention.

[FIG. 9] FIG. 9 is a cross-sectional view illustrating a second modification example of the main section of the power tool according to the embodiment of the present invention.

### DESCRIPTION OF EMBODIMENTS

A power tool according to an embodiment of the present invention will be described with reference to FIGS. 1 to 5. An impact driver 1 which is a power tool illustrated in FIG. 1 is a tool for fastening bolts, nuts, and screw threads with a tip tool, such as bits and sockets. The impact driver 1 mainly includes a housing 2, a motor 3, a gear mechanism 4, and an impact mechanism 5 and is driven with a rechargeable battery 6 as a power supply.

The housing 2 is a resin housing made from nylon 6, and includes a body part 2A accommodating the motor 3 etc. and a handle 2B extending from the body part 2A. Accommodation space is delimited in the body part 2A and the handle 2B. The housing 2 is configured with nearly symmetrical separate housings divided by a flat surface extending in the vertical direction and in the front-back direction to be described later. The motor 3, gear mechanism 4, and impact mechanism 5 are arranged in this order on the same axis in a part of the accommodation space delimited in the body part 2A. In the axial direction with this motor 3, the gear mechanism 4, and the impact mechanism 5 located in a line, the front-back direction is defined so that the motor 3 is on the backside and the impact mechanism 5 is on the front side. In addition, the vertical direction is defined such that the direction which perpendicularly intersects the front-back direction and in which the handle 2B extends from the body part 2A is defined as the downward direction, and the direction opposite to it is defined as the upward direction.

The body part 2A is configured to be substantially cylindrical so that it suits the appearance of the motor 3. As shown in FIG. 2, an inlet 21 and an outlet 22 (FIG. 4) which are air holes are formed on a right side and a left side of the body part 2A. The inlet 21 is formed at a rear position of the motor 3, and the outlet 22 is formed at a front position of the motor 3. The inlet 21 is covered with an inlet side lattice part 21A so that foreign matters may not enter in the housing 2. The inlet side lattice part 21A is integral with the housing 2 with a plurality of long size materials formed at the body part 2A in one piece. The long size materials extend in the vertical direction and in the direction that intersects the front-back direction at substantially 45 degrees. The plurality of long size materials are arranged in parallel at equal intervals.

The outlet 22 is located near a fan 32B to be described later, and is formed in the position opposing the outermost periphery of the fan 32B in the radial direction of the fan 32B. The outlet 22 is covered with a cover 70 so that foreign matters may not enter in the housing 2.

In addition, although only one cover 70 is shown in FIG. 2, the other side of the body part 2A illustrated in FIG. 2 is also provided with a cover which is not shown. Since the cover not shown and the cover 70 are mirror symmetry to each other, only the cover 70 will be described and explanation of the cover not shown will be omitted.

The cover 70 includes, as shown in FIG. 3, a main wall 71, an upper wall 72, a lower wall 73, a front side wall 74, and a back side wall 75. The length in the vertical direction of the main wall 71 is the largest in the end portion, and becomes smaller toward the front. Two screw holes 70a are formed in the nearly center in front-back direction of the main wall 71. One of the two screw holes 70a is formed near the upper end of the main wall 71, and the other one is formed near the lower end. A screw thread 70A (FIG. 2) is screwed together with each screw hole 70a to fix the cover 70 to the housing 2. By loosening the screw thread 70A, the cover 70 can be easily removed from the housing 2.

The first through holes 70b penetrating the main wall 71 are formed further forward than the screw holes 70a of the main wall 71. The first through holes 70b include a plurality of oblong holes extending at an angle of substantially 30 degrees in the vertical direction. The first through holes 70b are formed in the vertical direction in three lines. Six oblong holes are formed in the central line and the lower line, and five oblong holes are formed in the upper line. The six oblong holes in the central line are the longest in the longitudinal direction. Moreover, the three first through holes 70b are also formed at an end portion of the main wall 71 along a rear end edge of the main walls 71. The section 70B between the plurality of first through holes 70b formed in a front part of the main wall 71 and the plurality of first through holes 70b formed in the back part of the main walls 71 faces the outlet 22.

The back side wall 75 extends toward the housing 2 from the main wall 71 to be in contact with the housing 2. The back side wall 75 is provided from the upper end of the rear end edge to the lower end along the rear end edge of the main wall 71. The front side wall 74 extends toward the housing 2 from the main wall 71 to be in contact with the housing 2. The front side wall 74 is provided in the center portion in the vertical direction of the front end edge along the front end edge of the main wall 71. The upper wall 72 extends toward the housing 2 from the main wall 71 to be in contact with the housing 2. The upper wall 72 is provided in a section which faces the plurality of first through holes 70b formed further forward than the screw holes 70a along the upper end edge of the main wall 71. The lower wall 73 extends toward the housing 2 from the main wall 71 to be in contact with the housing 2. The lower wall 73 is provided in a section which faces the plurality of first through holes 70b formed further forward than the screw holes 70a along the lower end edge of the main wall 71.

The lower wall 73 and the front side wall 74 are not provided in the section to which the front end edge and lower end edge of the main wall 71 are connected. Similarly, the upper wall 72 and the front side wall 74 are not provided in the section to which the front end edge and the upper end edge of the main wall 71 are connected. The upper wall 72 is not provided in the section between the screw hole 70a and the back side wall 75 at the upper end edge of the main wall 71. Similarly, the lower wall 73 is not provided in the section between the screw holes 70a and the back side wall 75 at the lower end edge of the main wall 71. This configuration delimits second through holes 70c which connect the inside and the outside of the space surrounded by the cover 70 and the exterior surface of the housing 2.

More specifically, one of the second through holes 70c is formed in the section between the lower wall 73 and the front side wall 74 of the main wall 71. One of the second through holes 70c is formed in the section between the upper wall 72 and the front side wall 74 of the main wall 71. One of the second through holes 70c is formed in the section between the upper wall 72 and the back side wall 75 of the main wall 71. One of the second through holes 70c is formed in a section between the lower wall 73 and the back side wall 75 of the main wall 71. That is, one of the second through holes 70c is delimited by the main wall 71, the front side wall 74, the lower wall 73, and the external surface of the housing 2. Another one of the second through holes 70c is delimited by the main wall 71, the front side wall 74, the upper wall 72, and the external surface of the housing 2. Another one of the second through holes 70c is delimited by the main wall 71, the back side wall 75, the lower wall 73, and the external surface of the housing 2. Another second through hole 70c is delimited by the main wall 71, the back side wall 75, the upper wall 72, and the external surface of the housing 2. The position and the size to form the first through holes 70b and the second through holes 70c are decided based on IP4X of the IP (International Protection) standard defined in JIS C 0920. More specifically, the positions and sizes of the first through holes 70b and the second through holes 70c are decided so that a pin P of j1.0 can not be inserted into the housing 2 through the first through hole 70b or through the second through hole 70c and the outlet 22.

As shown in FIG. 1, at a lower end of the handle 2B, a terminal area 24 electrically connected to the battery 6 is arranged. A controlling circuit part 100 for controlling rotation of the motor 3 is arranged in the upper part of the terminal area 24. The root portion of the handle 2B is provided with a trigger 26A operated by an operator and a switch part 26B which is connected to the trigger 26A and the controlling circuit part 100 and controls the power feeding to the motor 3. At the root of the handle 2B which is also the upper part of the trigger 26A, a forward/reverse changeover lever, not shown, for changing the direction of rotation of the motor 3 is provided. At a lower part of the impact mechanism 5, an LED light 27 is provided to be connected to the controlling circuit part 100 and to irradiate with light towards the front side. In addition, around the motor 3 in the housing 2, a cooling passage 2c is formed from the inlet 21 to the outlet 22.

The motor 3 is a DC brushless motor and is mainly provided with a stator 31, a rotor 32, and a motor drive circuit arrangement 33. The stator 31 has a cylindrical shape and functions as the shell of the motor 3, and the peripheral surface is held at the housing 2.

The rotor 32 is rotatably arranged in the stator 31. In a position of the revolving shaft of the rotor 32, a rotor shaft 32A extending in the front-back direction is provided to coaxially and integrally rotate with the rotor 32. At a front end of the rotor shaft 32A, the fan 32B which is a centrifugal fan and a pinion gear 32C are equipped to coaxially and integrally rotate, a bearing 32D is equipped, and the rotor shaft 32A is supported by a frame 4A to be described later. In addition, the rear end of the rotor shaft 32A is equipped with a bearing 32E, and the rotor shaft 32A is supported by the body part 2A. The rotor shaft 32A is rotatably supported by these bearings 32D and 32E. The fan 32B rotates integrally with the rotor shaft 32A so that the air flow is formed which passes through the cooling passage 2C in the body part 2A (in the accommodation space) from the inlet 21 to the outlet 22.

The motor drive circuit arrangement 33 which is a circuit board is arranged at the rear position of the stator 31, fixed to the stator 31, and provided with a plurality of switching elements.

In the body part 2A, the gear mechanism 4 is arranged on the front side of the motor 3. The gear mechanism 4 is a planetary gear mechanism which uses the pinion gear 32C as a sun gear, and attached to the housing 2 using the frame 4A as the shell. The gear mechanism 4 includes a spindle 41, a ring gear 42, and a plurality of planet gears 43. The spindle 41 is a planet carrier which supports a plurality of the planet gears 43, coaxially rotatably supports an anvil 52 to be described later at its front end, and is rotatably supported by the frame 4A via the bearing 4B at its rear end. Near the rear end of the spindle 41, the planet gear 43 is supported and a flange 41A for receiving a first spring 54A to be described later is provided. A hammer 53 to be described later is movably provided around the spindle 41 in the front-back direction and a pair of slots 41a and 41a extending at an oblique angle to the axial direction are formed. Balls 41B and 41B are inserted respectively in the slots 41a, and these balls 41B and 41B connect the spindle 41 and the hammer 53.

The ring gear 42 is arranged at the outer circumference of the spindle 41, and non-rotatably fixed to the frame 4A. The plurality of planet gears 43 are rotatably supported by the spindle 41 with respect to the spindle 41, respectively, engaged to the ring gear 42, and also engaged to the pinion gear 32C. In the above-described configuration, rotation of the pinion gear 32C is slowed down and is transmitted to the spindle 41.

The impact mechanism 5 mainly includes a hammer case 51, the anvil 52, the hammer 53, and the first spring 54A. The hammer case 51 has a cylindrical shape having its front end narrower. A rear end portion of the hammer case 51 is connected to the body part 2A of the housing 2 coaxially with respect to the motor 3. A bearing 51A which rotatably supports the anvil 52 is provided at the front end portion.

The anvil 52 is configured to have a cylindrical shape extending in the front-back direction, and is rotatably supported by the hammer case 51 with the bearing 51A. The anvil 52 is rotatably supported by the spindle 41 with the end portion of the spindle 41 which is fit in a bore 52a by loose fitting formed in a rear end of the anvil 52. A tip tool mounting part 52A equipped with a socket not shown is provided at a front end portion of the anvil 52. The tip tool mounting part 52A mainly includes: a plurality of balls 52C which can project in a mounting hole 52b formed in the front end of the anvil 52; and a control part 52D which is energized backward with the spring. Also, the tip tool mounting part 52A is in contact with the ball 52C to project the ball 52C in the mounting hole 52b with the energization backward. In addition, at the rear end of the anvil 52, blade parts 52E and 52E, which are a pair of the engaged parts extending in the radial direction and in the opposite direction, are provided, respectively.

The hammer 53 is configured to have a cylindrical shape formed with a through hole 53a which is provided in an annular manner to the spindle 41. A front end of hammer 53 is provided with pawl parts 53A and 53A which are a pair of engagement parts and can be respectively engaged with the blade parts 52E and 52E. The pawl parts 53A and 53A are projecting to the front side from the front end of the hammer 53, are respectively arranged being apart by 180 degrees around the shaft, and are formed in a shape to be symmetrical around the shaft. The side intersecting the circumferential direction of these pawl parts 53A and 53A is configured to be in a slanting position so that the pawl part 53A may taper off to a point. Therefore, when load is applied to the hammer 53 against the anvil 52, the anvil 52 is moved to the front side relatively to the hammer 53 along this side; therefore, the blade parts 52E and 52E are moved over the pawl parts 53A and 53A and the hammer 53 can be rotated with respect to the anvil 52. Upon actual use, the anvil 52 can not be moved to the front side with respect to the housing 2; therefore, the hammer 53 is moved to the back side with respect to the anvil 52 so that the blade parts 52E and 52E are moved over the pawl parts 53A and 53A in the same manner and the hammer 53 can be rotated with respect to the anvil 52.

A surface of the through hole 53a of the hammer 53 is formed with slots 53b and 53b to which the pair of balls 41B and 41B are engaged respectively and which extend in the front-back direction. These slots 53b and 53b and the slots 41a and 41a are engaged with the balls 41B and 41B, respectively so that the hammer 53 can be coaxially and integrally rotated with respect to the spindle 41. In addition, on the rear end side of the hammer 53, a receiving part 53c for receiving the first spring 54A is formed in continuity around the wall delimiting the through hole 53a.

The first spring 54A is supported by the flange 41A of the spindle 41 via a washer. A front end portion located further forward than the flange 41A of the spindle 41 extends to the front in parallel with the first spring 54A. The first spring 54A is inserted in the receiving part 53c so that the hammer 53 is energized in the axial direction and to the front side with respect to the spindle 41. Therefore, the energizing direction of the first spring 54A is in agreement with the axial direction and the front side direction. The first spring 54A energizes the hammer 53 to the front side so that the pawl parts 53A and 53A of the hammer 53 can be engaged with the blade parts 52E and 52E of the anvil 52.

In addition, when the hammer 53 is moved back with respect to the anvil 52 under the load as described above, the first spring 54A moves the hammer 53 to the front to the anvil 52 side at the same time the blade parts 52E and 52E moves over the pawl parts 53A and 53A, and the pawl parts 53A and 53A abut on the blade parts 52E and 52E. Thus, the hammer 53 rotates with respect to the anvil 52, and the pawl parts 53A and 53A abut on the blade parts 52E and 52E so that the striking power in the direction of rotation is applied to the anvil 52.

Water and foreign matter which entered in the space surrounded by cover 70 and the external surface of the housing 2 from the outside of the cover 70 via the first through hole 70b of the cover 70 collide with the housing 2 as shown by the arrow A in FIGS. 4 and 5 and thus can not enter the housing 2 through the outlet 22 of the housing 2. Water and foreign matter which entered in the space surrounded by the cover 70 and the external surface of the housing 2 then fall with the gravity along the external surface of the housing 2, and are discharged through the second through hole 70c to the outside of the cover 70.

Moreover, since the first through hole 70b and second through hole 70c are formed, the passage area of the air as shown by the arrow B in FIG. 4 can be fully ensured. Therefore, the flow of the air discharged from the outlet 22 is not prevented.

Positional relationships of the first through hole 70b, the second through hole 70c, and the outlet 22, and the sizes thereof are based on IP4X of the IP standard defined in JIS C 0920. Therefore, even if a cylindrical pin etc. is inserted from the first through hole 70b and the second through hole 70c, if the pin is of j1.0 or larger, it will not be inserted into the housing 2, and the fan's rotation is not prevented by the pin etc.

Moreover, since the second through hole 70c is formed at a front end portion, a bottom end portion, and a top end portion of the cover 70, when fastening threads etc. with the tip tool, the direction from the first through hole 70b to the second through hole 70c nearly coincide with the gravity direction. Therefore, rainwater and foreign matter which flowed into the space surrounded by the cover 70 and the housing 2 through the first through hole 70b can be easily discharged from the second through hole 70c using the gravity.

Since the cover 70 can be removed from the housing 2, even if foreign matters remain between the housing 2 and the cover 70, foreign matter can be easily removed by removing the cover 70 from the housing 2.

The power tool according to the present invention is not limited to the embodiment described above, and various improvements and modifications may be made without departing from the scope of the claims. For example, the cover 70 is provided to cover the outlet 22 in this embodiment but not limited thereto and the cover may be provided to cover the inlet.

In addition, the cover is not limited to the form and the configuration of this embodiment. For example, as shown in FIG. 6, a projection 176 may be provided on a housing-facing surface 170E which is a surface of a cover 170 and which faces the housing 2. The projection 176 is provided at a position which is a part of the housing-facing surface 170E and which faces the outlet 22. The projection 176 has a nearly angle-shaped cross section when cut by a plane including a virtual straight line extending in the front-back direction and a virtual straight line extending in the vertical direction. As shown in the cross cross-sectional view illustrated in FIG. 6, the external surface of the projection 176 connecting a projecting end of the projection 176 and the housing-facing surface 170E is formed with a curved surface 176A which forms a curve with the fan-like slope which smoothly connects the projecting end and the housing-facing surface 170E.

For this reason, when the cover covers the inlet, the external surface of the projection 176 can guide the air flowing into the inlet port. When the cover 170 covers the outlet 22, as shown by the arrow B in FIG. 6, the external surface of the projection 176 can guide the air flowing out of the outlet 22. Therefore, stagnation of air in the space surrounded by the cover 170 and the housing 2 can be prevented.

Moreover, the outlet 22 covered with the cover and the protective barrier 2C surrounding the inlet can be provided. More specifically, for example, as shown in FIG. 7, the outlet 22 is composed of the seven oblong holes oriented in the front-back direction and arranged in line in the vertical directions. The protective barrier 2C is formed with the housing 2 in one piece and extends from the exterior surface of the housing 2 so that the protective barrier 2C surrounds these seven outlets 22. Since the projecting amount is not sufficient to reach the housing-facing surface 170E of a cover 270, the flow of the air from the outlet 22 is hardly prevented. However, as shown by the arrow A in FIG. 9, foreign matters, rainwater, etc. which entered in the space surrounded by the cover 270 and the housing 2 can be prevented from going along the exterior surface of the housing 2 into the housing 2 through the outlet 22. Moreover, since the protective barrier 2C is formed with the housing 2 in one piece, the protective barrier 2C with high strength can be obtained.

Moreover, the protective barrier does not need to be formed with the housing in one piece. For example, as illustrated in FIG. 9, a protective barrier 270F may be formed with the cover in one piece. In that manner, the increase in the parts count concerning the protective barrier 270F can be prevented. In addition, the cover can be easily formed.

### INDUSTRIAL APPLICABILITY

The power tool of the present invention is not limited to the impact driver herein, and can be generally and widely used for power tools having a motor and a fan, as well as an inlet and an outlet in the housing.

1. A power tool comprising:
a motor for driving the tip tool;
a housing accommodating the motor; and an air hole formed in the housing and connecting the outside and the inside of the housing, wherein a cover for covering the air hole is provided to the outside of the housing;
a first through hole is formed on a part off from a part of the cover facing the air hole in the direction connecting the outside and the inside of the housing, penetrating the cover in a direction connecting the outside and the inside of the housing;
a second through hole is formed on another part of the cover, penetrating the cover in a direction along an exterior surface of the housing.

2. The power tool according to claim 1,
wherein the cover has a housing-facing surface which faces the housing;
a projection projecting toward the air hole is provided on a part of the housing-facing surface and which faces the air hole; and
the external surface of the projection includes a curved surface smoothly connecting an projecting end of the projection and the housing-facing surface.

3. The power tool according to claim 1,
wherein a protective barrier arranged to project from the exterior surface of the housing and to surround the air hole is provided on a part which is a part of the exterior surface of the housing and which surrounds the air hole.

4. The power tool according to claim 3,
wherein the protective barrier and the cover are formed in one piece.

5. The power tool according to claim 3,
wherein the protective barrier and the housing are formed in one piece.

6. The power tool according to claim 1,
wherein a fan driven by the motor is provided and the air hole formed on a part of the housing facing the fan's periphery.

7. The power tool according to claim 1,
wherein the housing includes: a tip portion for supporting the tip tool; a rear end portion on the opposite end of the tip portion; and a handle extending in a direction intersecting the direction connecting the tip portion and the rear end portion, and
the second through hole is formed on: a part closest to a front end portion of the cover; an end portion in an extending direction of the handle of the cover; and an end portion in a direction opposite to the extending direction of the handle of the cover.

8. The power tool according to claim 1,
wherein the cover can be removed from the housing.
